(19) United States
(12) Patent Application Publication
(10) Pub. No.: US 2003/0139931 A1
(43) Pub. Date: Jul. 24, 2003

(54) Client device of thin client network system and method of controlling the same

(75) Inventor: Jin-youl Park, Seoul City (KR)

Correspondence Address: STAAS & HALSEY LLP, 700 11TH STREET, NW, SUITE 500, WASHINGTON, DC, 20001, US

(73) Assignee: Samsung Electronics Co., Ltd., Suwon-city (KR)

(21) Appl. No.: 10/184,893

(22) Filed: Jul. 1, 2002

(30) Foreign Application Priority Data
Jan. 21, 2002 (KR) 2002-3313

(51) Int. Cl. G10L 11/00

(52) U.S. Cl. 704/275

(57) ABSTRACT

A client device of a thin client network system. The client device connects with a server provided with a plurality of application programs through a network, demands execution ot one of the application programs, and displays a result of the execution transmitted from the server. The client device includes a speaker which outputs sounds based on sound data transmitted from the server. A volume controller in the client device controls output sound volume based on a volume control signal input through a volume control signal input part. A key signal controller determines whether a key signal input from the volume control input part, such as a keyboard, a mouse, or a touch screen, is a key signal for controlling the volume or a key signal for signaling the server to execute one of the application programs and directs the key signal accordingly.

### CROSS REFERENCE TO RELATED APPLICATIONS

This application claims the benefit of Korean Application No. 2002-3313 filed Jan. 21, 2002, in the Korean Patent Office, the disclosure of which is incorporated herein by reference.

### BACKGROUND OF THE INVENTION

1. Field of the Invention

The present invention relates in general to a client device of a thin client network system and a method of controlling the same, and more particularly, to a client device of a thin client network system having a volume control function and a method of controlling the volume control function.

2. Description of the Related Art

Client/server systems may be characterized as having a fat client or a thin client. In a client/server system having the fat client, most of the operations are processed in the client and the client requires high performance in order to share data through a network and to process the data. In a client/server system having the thin client, most of the operations are performed in the server. Thus, it is expected that the fat client will initially cost more than the thin client, and that the fat client will require more maintenance and management than the thin client.

In view of these characteristics of complexity and cost, there is a growing tendency to utilize a thin client network system in which a load due to application programs is concentrated on a server and a load on the client is reduced.

In the thin client network system, all application programs are provided on the server, and the thin client has access to the application programs of the server though the network. That is, the application programs are installed only on the server, and used by a plurality of thin clients accessing the server. Thus, the thin client network system is being widely used because maintaining, managing and upgrading the application programs on the thin client network system is more convenient than maintaining, managing and upgrading the application programs on the fat client network system.

In the thin client network system, a client device is comprised of a minimum number of hardware modules necessary for operating a computer. In the server, all application programs are installed and executed, and data is processed and stored. In the thin client device, data received from the server is output, and data is input through a keyboard, a mouse, etc. Particularly, in the case of sound data, the thin client device receives a sound signal from the server through the network, amplifies it with an audio CODEC (coder/decoder), and outputs the amplified sound signal to a speaker.

However, in the thin client network system, the client device is provided with only the audio CODEC and the speaker for outputting sound based on the sound data, and is not provided with an ability to control a volume of the sound corresponding to the sound data. Further, the client device is prevented from accessing the server in order to operate the software program which controls the volume of sounds which are to be reproduced by the CODEC based on the sound data because the access would affect a program setting of the server.

Thus, in the conventional thin client network system, a user using the client device cannot control the volume of sound reproduced from the sound data received from the server.

### SUMMARY OF THE INVENTION

Accordingly, the present invention has been made keeping in mind the above-described shortcomings and a user's need, and an object of the present invention is to provide a thin client network system having a volume control function and a method of controlling the same.

Additional objects and advantages of the invention will be set forth in part in the description which follows, and, in part, will be obvious from the description, or may be learned by practice of the invention.

The above and other objects of the present invention are accomplished by providing a client device of a thin client network system, which connects with a server provided with a plurality of application programs through a network, demands execution of at least one of the plurality of application programs, and displays a result of the execution transmitted from the server, the thin client device comprising: a speaker which outputs a sound based on sound data transmitted from the server; a volume control signal input part which inputs a volume control signal to control the volume of the sound corresponding to the sound data; and a volume controller which controls the volume of the sound corresponding to the sound data transmitted from the server on the basis of the volume control signal input through the volume control signal input part, and outputs a signal to the speaker according to the controlled volume.

Preferably, the volume control signal input part comprises a keyboard which inputs data, and a keyboard driver which transmits a key signal input through the keyboard to the volume controller if the key signal is determined as the volume control signal generated by a predetermined combination of keys for controlling the volume of sound reproduced from the sound data; and the volume controller controls the volume of the sound output to the speaker on the basis of the key signal transmitted from the keyboard driver.

Preferably, the client device further comprises a memory which stores data on, volume control according to a plurality of key signals generated through the combination of the predetermined keys for controlling the volume, and wherein the volume controller reads the volume control data of the memory in response to the key signal transmitted from the keyboard driver, and controls the volume of the sound output to the speaker.

Preferably, the keyboard driver prevents the key signal input through the keyboard from being transmitted to the server if the key signal is determined as the volume control signal according to the combination of the predetermined keys.

According to another aspect of the present invention, the above and other objects are also achieved by providing a method of controlling a client device of a thin client network system, in which sound corresponding to sound data transmitted from a server is output to a speaker of the client device, the method comprising: setting up a combination of predetermined keys for controlling the volume of sound corresponding to the sound data; determining whether a key signal input through a keyboard is a volume control signal according to the combination of predetermined keys; and controlling the volume of sound corresponding to the sound data transmitted from the server on the basis of the key signal if the key signal is determined as the volume control signal.

Preferably, the method further comprises preventing the key signal from being transmitted to the server if the key signal is determined as the volume control signal.

### BRIEF DESCRIPTION OF THE DRAWINGS

The present invention will be better understood and its various objects and advantages will be more fully appreciated from the following description taken in conjunction with the accompanying drawings, in which:

FIG. 1 is a block diagram of a thin client network system;

FIG. 2 is a control block diagram of the thin client network system having a client device according to the present invention;

FIG. 3 is a control block diagram of a keyboard driver of FIG. 2; and

FIG. 4 is a control flow chart of the client device for the thin client network system according to the present invention.

### DESCRIPTION OF THE PREFERRED EMBODIMENT

Reference will now be made in detail to the present embodiments of the present invention, examples of which are illustrated in the accompanying drawings, wherein like reference numerals refer to like elements throughout.

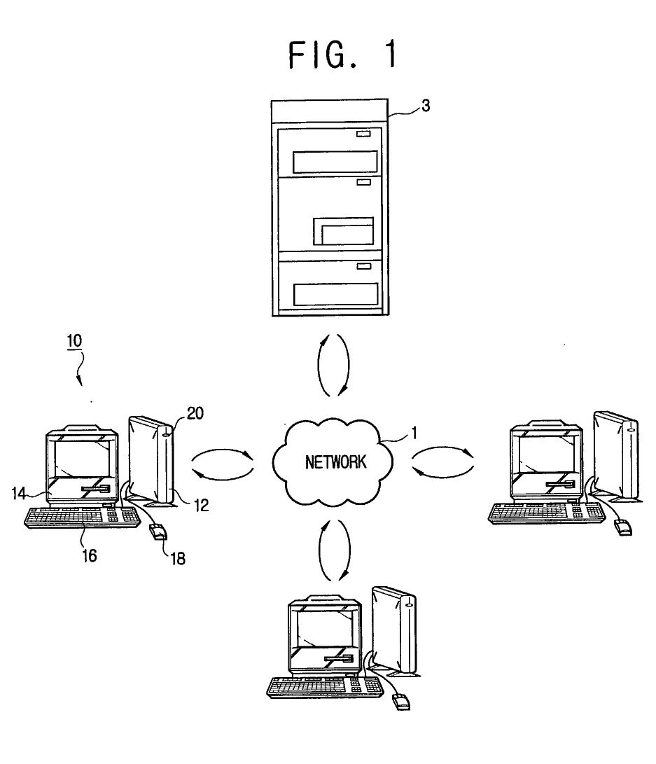

In the thin client network system shown in FIG. 1, all application programs are provided in a server 3, and a client device 10 has access to the application programs of the server 3 though the network 1.

The client device 10 comprises a main body 12 provided with a minimum of hardware modules necessary to drive an operating system, a monitor 14 which displays data received from the server 3, an input device such as a keyboard 16, a mouse 18, etc., which inputs data to be transmitted to the server 3, and a speaker 20 which outputs a sound based on sound data transmitted from the server 3.

The client device 10 demands execution of an application program (e.g., a window media player, a word processor, etc.) provided in the server 3 by inputting an operation signal through one of the input devices 16 or 18. Accordingly, while the application program is run by request of the client device 10, the server 3 proceeds with operations such as processing, storing, etc., and transmitting operation results as graphic data to the client device 10. Then, the client device 10 receives the graphic data from the server 3 and outputs the graphic data to the monitor 14, thereby showing the operation results to a user.

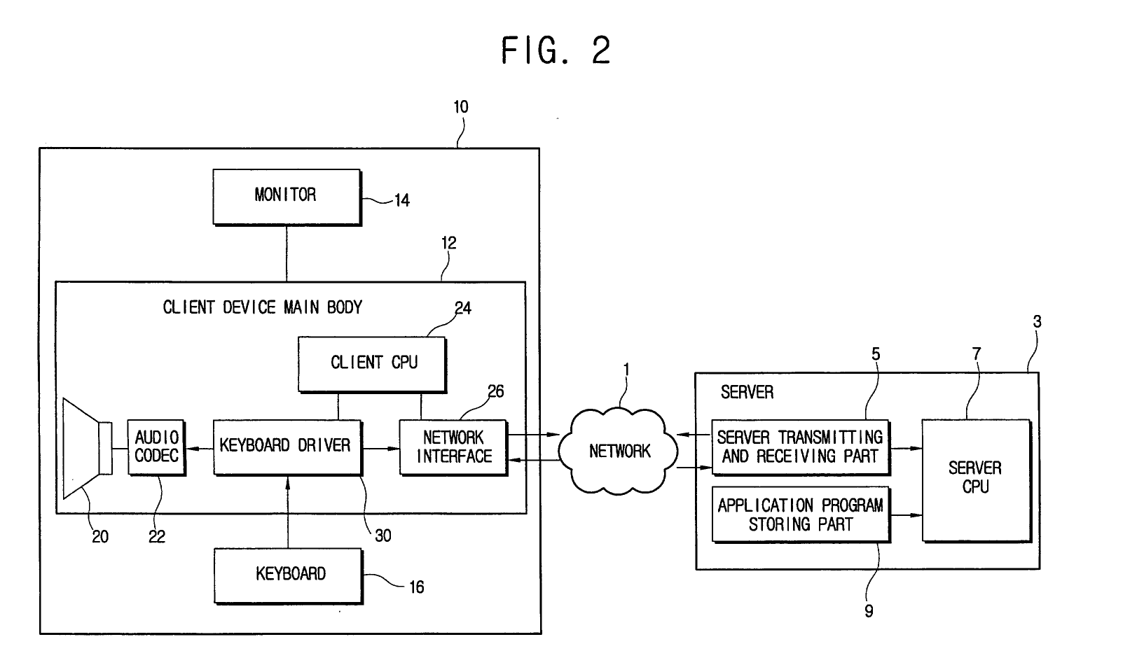

As shown in FIG. 2, the thin client network system according to the present invention comprises a server 3, a thin client 10 and a network 1.

The server 3 comprises a server transmitting/receiving part 5 which connects with the client device 10, a server CPU (central processing unit) 7, and an application program storing part 9 which stores a plurality of application programs, thereby processing data received from the client device 10 through the network 1 and transmitting results of the processing to the client device 10.

The client device 10 comprises a network interface 26 which connects with the network 1, a client CPU 24, an audio CODEC 22 which processes sound data received from the server 3 to output a sound signal, a speaker 20 which outputs a sound in response to the sound signal, a keyboard driver 30 which transmits a key signal input from the keyboard 16 to the server 3 or the audio CODEC 22.

The network interface 26 connects the client device 10 and the server 3 through the network 1 such as the Internet, an Intranet, etc., so that data is communicated between the client device 10 and the server 3. That is, the client device 10 orders the application programs or the server 3 to be executed and inputs data to the server 3 through the network interface 26. Further, the graphic data transmitted from the server 3 through the network interface 26 is displayed on the monitor 14 according to control of the client CPU 24, and the sound data transmitted from the server 3 through the network interface 26 is converted into a signal corresponding to the sound data and amplified by the audio CODEC 22. The amplified signal is output to the speaker 20.

The keyboard driver 30 recognizes a key signal input from the keyboard 16, and transmits the key signal to the server 3 directly or transmits the key signal to the audio CODEC 22 after processing the key signal.

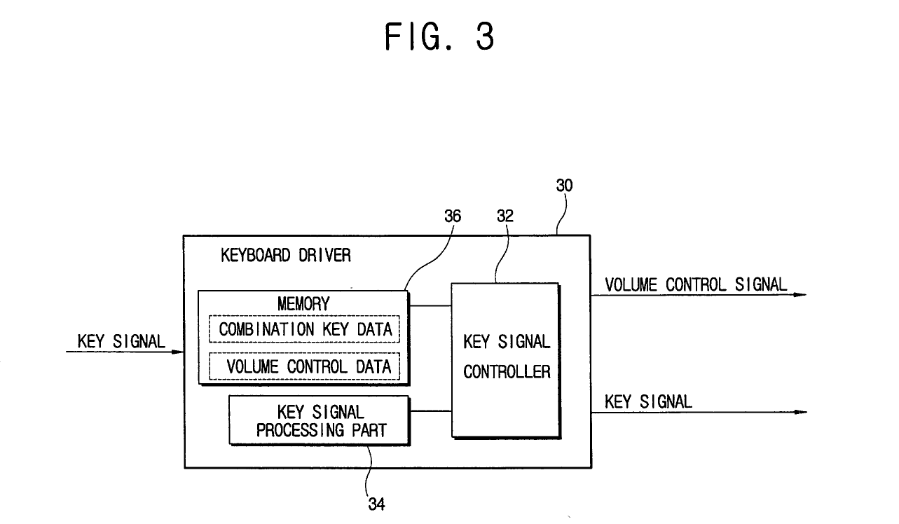

As shown in FIG. 3, the keyboard driver 30 comprises a key signal processing part 34 which converts a key signal into a signal adopted by the thin client system, a memory 36 which stores data on volume control according to a key signal input from specific keys, such as a function key and a combination of keys provided in the keyboard 16 to control the volume, and a key signal controller 32 which determines whether the key signal input from the keyboard 16 is a volume control key signal stored in the memory 36, and transmits the key signal to the server 3 through the network interface 26 or the volume control signal to the audio CODEC 22 according to the determination.

The memory 36 of the keyboard driver 30 stores data on a combination of predetermined keys to control the volume and on a control to be executed in response to each combination of the predetermined keys. For example, the memory 36 stores data on turning up the volume in response to simultaneously selecting <Ctrl> and <Shift> and <+> keys, and stores data on turning down the volume in response to simultaneously selecting <Ctrl> and <Shift> and <−> keys. Further, the memory 36 may store data on the volume corresponding to each key signal.

The key signal controller 32 reads the volume control data according to the volume control key signal from the memory 36 where a key signal input from the keyboard 16 is determined as the volume control key signal for controlling the volume, and transmits the volume control data to the audio CODEC 22, thereby controlling the volume of sound corresponding to the sound data. In this case, contrary to a key signal for controlling the application program of the server 3, the key signal controller 30 does not transmit the volume control key signal for controlling the volume to the server 3.

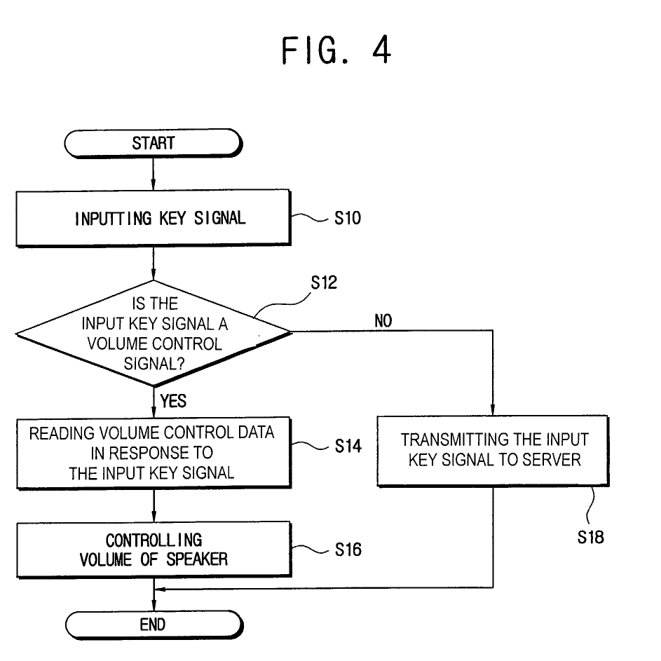

A process of controlling the volume in the client device 10 having the keyboard driver 30 will be described referring to FIG. 4.

In response to a key signal input from the keyboard 16 (S10), the key signal controller 32 of the keyboard driver 30 determines whether the input key signal is the volume control key signal based on the data on the combination of the keys stored in the memory 36 (S12). If the input key signal is a key signal for controlling the application program of the server 3, the key signal controller 32 transmits the key signal to the server 3 through the network interface 26 (S18).

If the input key signal is the volume control key signal for controlling the volume, the key signal controller 32 prevents the volume control key signal from being transmitted to the server 3, and reads the volume control data in response to the volume control key signal from the memory 36 (S14). The key signal controller 32 of the keyboard driver 30 transmits the volume control signal to the audio CODEC 22 according the volume control key signal, thereby controlling the volume (S16). Thus, the user easily controls the volume of the sound data transmitted from the server 3 with the keyboard 16.

As described above, according to the present invention, the volume of the sound data transmitted from the server is controlled in the client device with the keyboard employed as an input device. That is, when an input key signal is determined as the volume control key signal, the volume control signal is prevented from being transmitted to the server and transmitted to the audio CODEC of the client device, thereby controlling the volume.

Further, in the thin client network system, the volume control of the client device may be accomplished with hardware. Herein, the client device is provided with a volume control button employed in a general audio circuit for controlling the volume, and a volume control signal output from the volume control button is directly transmitted to an audio CODEC.

As described above, the present invention provides a thin client network system having a volume control function and a method of controlling the same.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A client device of a thin client network system, which connects with a server provided with a plurality of application programs through a network, demands execution of at least one of the plurality of application programs, and displays a result of the execution transmitted from the server, the client device comprising:
a speaker which outputs a sound based on sound data transmitted from the server;
a volume control signal input part which inputs a volume control signal; and
a volume controller which controls a volume of the output sound based on the volume control signal.

2. The client device according to claim 1, wherein:
the volume control signal input part comprises:
a keyboard which inputs data, and
a keyboard driver which transmits a key signal input through the keyboard to the volume controller if the key signal is determined as the volume control signal generated by a combination of predetermined keys of the keyboard; and
the volume controller controls the volume of the sound based on the key signal transmitted from the keyboard driver.

3. The client device according to claim 2, further comprising a memory which stores data on volume control according to a plurality of key signals generated through corresponding combinations of the predetermined keys, and
wherein the volume controller reads the volume control data of the memory in response to at least one key signal transmitted from the keyboard driver, and controls the volume of the sound in response to the read volume control data.

4. The client device according to claim 2, wherein the keyboard driver prevents the input key signal from being transmitted to the server if the key signal is determined as the volume control signal according to the combination of the predetermined keys.

5. The client device according to claim 3, wherein the keyboard driver prevents the input key signal from being transmitted to the server if the key signal is determined as the volume control signal according to the combination of the predetermined keys.

6. A method of controlling a client device of a thin client network system, in which sound data transmitted from a server is outputted to a speaker of the client device, comprising:
setting up a combination of predetermined keys for controlling the volume of the sound data;
determining whether a key signal input through a keyboard is a volume control signal according to the combination of the predetermined keys; and
controlling the volume of a sound corresponding to the transmitted sound data based on the key signal when the key signal is determined as the volume control signal.

7. The method according the claim 6, further comprising preventing the key signal from being transmitted to the server when the key signal is determined as the volume control signal.

8. A thin client device of a thin client network system comprising the thin client device, a server and a network connecting the thin client device to the server, the thin client device comprising:
a keyboard which inputs a key signal corresponding to one or a combination of keys of the keyboard;
a memory which stores data corresponding to the input key signal;
a function controller which controls a function of the thin client device based on data transmitted by the server and modifies the data provided by the server based on the input key signal; and
a keyboard driver which accesses the memory and determines whether the input key signal is transmitted to the server via the network or transmitted to the function controller.

9. The thin client device of claim 8, wherein the function controller is a sound volume controller.

10. A thin client device of a thin client network system comprising the thin client device, a server and a network connecting the thin client device to the server, the thin client device comprising:
an input device which inputs a signal;
a function controller which controls a function of the thin client device based on data transmitted by the server and modifies the data provided by the server based on the input signal;
a memory which stores data corresponding to the input signal; and
a driver which accesses the memory and determines whether the input signal is transmitted to the server via the network or transmitted to the function controller.

11. The thin client device of claim 10, wherein:
the input device is a keyboard; and
the input signal is generated by a combination of predetermined keys of the keyboard.

12. The thin client device of claim 10, wherein:
the input device is a mouse; and
the input signal is generated by activating a key of the mouse.

13. The thin client device of claim 10, wherein:
the input device is a touch screen; and
the input signal is generated by touching a predetermined portion of a display screen.

14. A computer readable medium which provides instructions for operation of a thin client network system comprising a thin client device, a server and a network connecting the thin client device to the server, the computer readable medium comprising:
a first area which stores instructions which:
instruct the thin client device to make a determination whether a key signal input by an input device requests the server to perform an operation or requests the thin client device to modify data transmitted from the server before converting the data to user usable form in the thin client device,
instruct the thin client device to transmit the key signal to the server if the key signal is determined to be the request to the server, and
instruct the thin client device to modify data transmitted from the server to the thin client device if the key signal is determined to be the request to the thin client device; and
a second area which stores data usable by the thin client device to make the determination.

15. The computer readable medium of claim 14, wherein:
the instructions stored in the first area instruct the thin client device to determine whether a combination of keys input by a keyboard represent the request to the server or the request to the thin client device; and
the data stored in the second area identifies a first predetermined combination of keys corresponding to the request to the server and a second predetermined combination of keys corresponding to the request to the thin client device.

16. The computer readable medium of claim 14, wherein:
the instructions stored in the first area instruct the thin client device to modify a sound volume of a sound corresponding to sound data transmitted from the server to the thin client device if the key signal is determined to be the request to the thin client device.
